(19) United States
(12) Patent Application Publication
(10) Pub. No.: US 2025/0148391 A1
(43) Pub. Date: May 8, 2025

(54) Resource Allocation for Power, Communication, and Transportation Infrastructure Restoration usingDistributed Fiber Optic Sensing

(71) Applicant: NEC Laboratories America, Inc., Princeton, NJ (US)

(72) Inventors: Yangmin DING, East Brunswick, NJ (US); Ting WANG, West Windsor, NJ (US)

(73) Assignee: NEC Laboratories America, Inc., Princeton, NJ (US)

(21) Appl. No.: 18/935,505

(22) Filed: Nov. 2, 2024

Related U.S. Application Data
(60) Provisional application No. 63/595,892, filed on Nov. 3, 2023.

(51) Int. Cl. G06Q 10/0631

(52) U.S. Cl. CPC G06Q 10/06315; G06Q 10/06316

(57) ABSTRACT

Disclosed are integrated systems and methods that utilize a network of DFOS sensors installed on power lines, communication networks, and transportation systems, which continuously monitor infrastructures and provide real-time data. This data is collected, processed, and analyzed, and used to identify any affected areas of infrastructure and assess severity of any damage. Prioritization and resource allocation is performed and uses this analysis to prioritize restoration efforts and allocate resources such as repair crews, equipment, and materials to areas with a highest priority.

### CROSS-REFERENCE TO RELATED APPLICATIONS

This application claims the benefit of U.S. Provisional Patent Application Ser. No. 63/595,892 filed Nov. 3, 2023, the entire contents of which is incorporated by reference as if set forth at length herein.

### FIELD OF THE INVENTION

This application relates generally to distributed fiber optic sensing (DFOS) systems, methods, structures, and related technologies. More particularly, it pertains to resource allocation for power, communication, and transportation infrastructure using DFOS.

### BACKGROUND OF THE INVENTION

Distributed fiber optic sensing (DFOS) systems, methods, and structures have found widespread utility in contemporary industry and society. Of particular importance, DFOS techniques have been used to usher in a new era of monitoring including perimeter security, traffic monitoring, and civil infrastructure monitoring. They can provide continuous, real-time measurements over long distances with high sensitivity, making them valuable tools for infrastructure monitoring and maintenance.

Environmental and man-made disasters oftentimes lead to extensive damage to power, communication, and transportation infrastructure and resulting outages. Restoring these critical systems is a challenging and time-consuming process due to limited resources and the need for coordination among various stakeholders. As such, systems and methods that facilitate the detection and restoration of damaged infrastructure resulting from disasters would represent a welcome addition to the art.

### SUMMARY OF THE INVENTION

An advance in the art is made according to aspects of the present disclosure directed to systems and methods providing resource allocation for the restoration of power, communication, and transportation infrastructure using distributed fiber optic sensing technology. Our inventive systems and methods advance state of the art by introducing real-time monitoring, improved prioritization, better coordination among infrastructures, increased resilience and redundancy, and more effective preventive maintenance.

In sharp contrast to the prior art, systems and methods according to aspects of the present disclosure utilize a network of DFOS sensors installed on power lines, communication networks, and transportation systems, which continuously monitor infrastructures and provide real-time data. This data is collected, processed, and analyzed, and used to identify any affected areas of infrastructure and assess severity of any damage. Prioritization and resource allocation is performed and uses this analysis to prioritize restoration efforts and allocate resources such as repair crews, equipment, and materials to areas with a highest priority.

Additionally, coordination and communication is established among power, communication, and transportation systems, facilitating better coordination and collaboration during a restoration process. Resilience and redundancy enhancement is provided by using data collected from the fiber optic sensors to identify potential vulnerabilities and weaknesses in the infrastructure which assists in creating redundancies to enhance the resilience of the systems. Lastly, the preventive maintenance is provided by continuously monitoring using DFOS to detect any indications of wear, corrosion, or other potential issues and automatically schedules preventive maintenance to minimize the risk of future failures or damage.

### BRIEF DESCRIPTION OF THE DRAWING

FIG. 1(A) and FIG. 1(B) are schematic diagrams showing an illustrative prior art uncoded and coded DFOS systems.

FIG. 2 is a schematic diagrams showing illustrative inter-operation of components of systems and methods according to aspects of the present disclosure.

FIG. 3 is a schematic flow diagram showing illustrative operational flow of systems and methods according to aspects of the present disclosure.

FIG. 4 is a schematic flow diagram showing illustrative coordination and communication of systems and methods according to aspects of the present disclosure.

FIG. 5 is a schematic flow diagram showing illustrative resilience and redundancy enhancement operation of systems and methods according to aspects of the present disclosure.

FIG. 6 is a schematic flow diagram showing illustrative preventative maintenance flow of systems and methods according to aspects of the present disclosure.

FIG. 7 is a schematic flow diagram showing illustrative overall operational flow of systems and methods according to aspects of the present disclosure.

FIG. 8 is a schematic diagram showing illustrative feature hierarchy systems and methods according to aspects of the present disclosure.

FIG. 9 is a schematic block diagram of an illustrative computing system that may be programmed with instructions that when executed produce the methods/algorithms according to aspects of the present invention.

### DETAILED DESCRIPTION OF THE INVENTION

The following merely illustrates the principles of this disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are intended to be only for pedagogical purposes to aid the reader in understanding the principles of the disclosure and the concepts contributed by the inventor(s) to furthering the art and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any block diagrams herein represent conceptual views of illustrative circuitry embodying the principles of the disclosure.

Unless otherwise explicitly specified herein, the FIGS comprising the drawing are not drawn to scale.

By way of some additional background, we note that distributed fiber optic sensing systems convert the fiber to an array of sensors distributed along the length of the fiber. In effect, the fiber becomes a sensor, while the interrogator generates/injects laser light energy into the fiber and senses/detects events along the fiber length.

As those skilled in the art will understand and appreciate, DFOS technology can be deployed to continuously monitor vehicle movement, human traffic, excavating activity, seismic activity, temperatures, structural integrity, liquid and gas leaks, and many other conditions and activities. It is used around the world to monitor power stations, telecom networks, railways, roads, bridges, international borders, critical infrastructure, terrestrial and subsea power and pipelines, and downhole applications in oil, gas, and enhanced geothermal electricity generation. Advantageously, distributed fiber optic sensing is not constrained by line of sight or remote power access and —depending on system configuration—can be deployed in continuous lengths exceeding 30 miles with sensing/detection at every point along its length. As such, cost per sensing point over great distances typically cannot be matched by competing technologies.

Distributed fiber optic sensing measures changes in “backscattering” of light occurring in an optical sensing fiber when the sensing fiber encounters environmental changes including vibration, strain, or temperature change events. As noted, the sensing fiber serves as sensor over its entire length, delivering real time information on physical/environmental surroundings, and fiber integrity/security. Furthermore, distributed fiber optic sensing data pinpoints a precise location of events and conditions occurring at or near the sensing fiber.

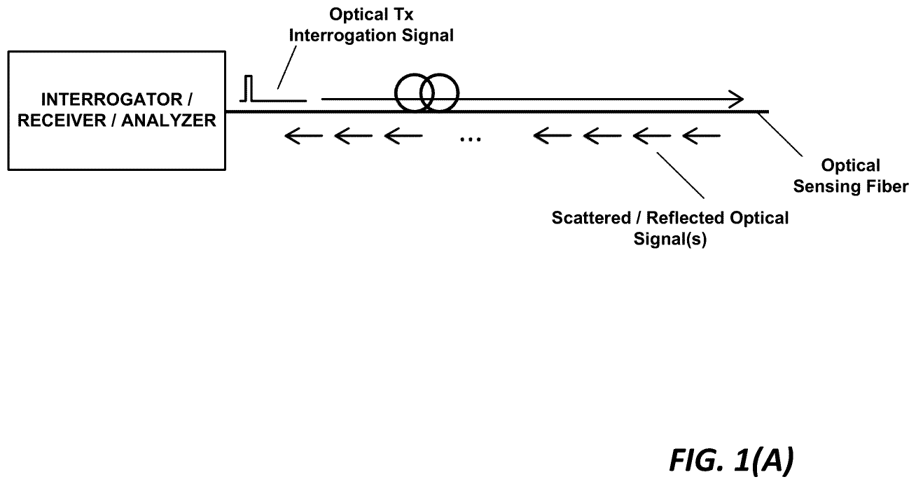

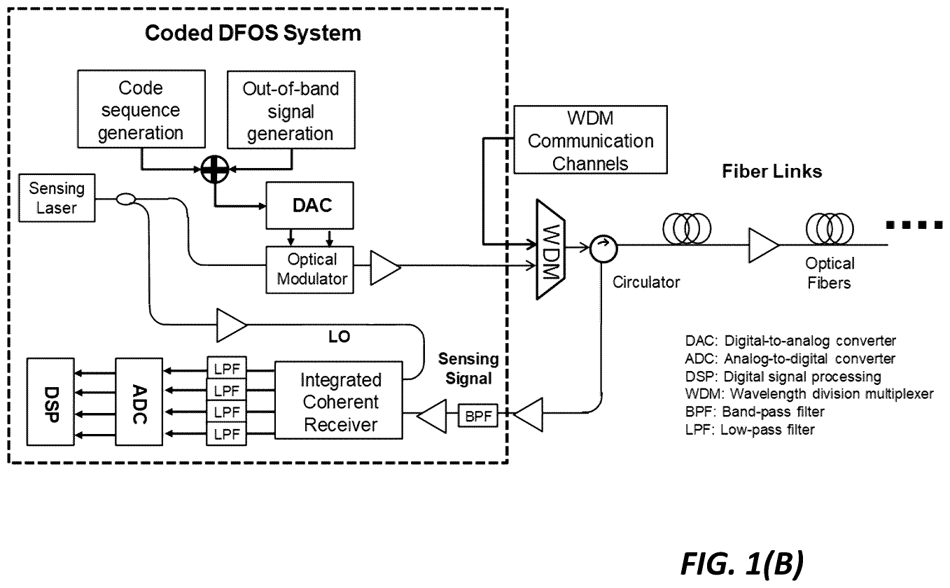

A schematic diagram illustrating the generalized arrangement and operation of a distributed fiber optic sensing system that may advantageously include artificial intelligence/machine learning (AI/ML) analysis is shown illustratively in FIG. 1(A). With reference to FIG. 1(A), one may observe an optical sensing fiber that in turn is connected to an interrogator. While not shown in detail, the interrogator may include a coded DFOS system that may employ a coherent receiver arrangement known in the art such as that illustrated in FIG. 1(B).

As is known, contemporary interrogators are systems that generate an input signal to the optical sensing fiber and detects/analyzes reflected/backscattered and subsequently received signal(s). The received signals are analyzed, and an output is generated which is indicative of the environmental conditions encountered along the length of the fiber. The backscattered signal(s) so received may result from reflections in the fiber, such as Raman backscattering, Rayleigh backscattering, and Brillion backscattering.

As will be appreciated, a contemporary DFOS system includes the interrogator that periodically generates optical pulses (or any coded signal) and injects them into an optical sensing fiber. The injected optical pulse signal is conveyed along the length optical fiber.

At locations along the length of the fiber, a small portion of signal is backscattered/reflected and conveyed back to the interrogator wherein it is received. The backscattered/reflected signal carries information the interrogator uses to detect, such as a power level change that indicates—for example —a mechanical vibration.

The received backscattered signal is converted to electrical domain and processed inside the interrogator. Based on the pulse injection time and the time the received signal is detected, the interrogator determines at which location along the length of the optical sensing fiber the received signal is returning from, thus able to sense the activity of each location along the length of the optical sensing fiber. Classification methods may be further used to detect and locate events or other environmental conditions including acoustic and/or vibrational and/or thermal along the length of the optical sensing fiber.

Of particular interest, distributed acoustic sensing (DAS) is a technology that uses fiber optic cables as linear acoustic sensors. Unlike traditional point sensors, which measure acoustic vibrations at discrete locations, DAS can provide a continuous acoustic/vibration profile along the entire length of the cable. This makes it ideal for applications where it's important to monitor acoustic/vibration changes over a large area or distance.

Distributed acoustic sensing/distributed vibration sensing (DAS/DVS), also sometimes known as just distributed acoustic sensing (DAS), is a technology that uses optical fibers as widespread vibration and acoustic wave detectors. Like distributed temperature sensing (DTS), DAS/DVS allows for continuous monitoring over long distances, but instead of measuring temperature, it measures vibrations and sounds along the fiber.

DAS/DVS operates as follows.

Light pulses are sent through the fiber optic sensor cable.

As the light travels through the cable, vibrations and sounds cause the fiber to stretch and contract slightly.

These tiny changes in the fiber's length affect how the light interacts with the material, causing a shift in the backscattered light's frequency.

By analyzing the frequency shift of the backscattered light, the DAS/DVS system can determine the location and intensity of the vibrations or sounds along the fiber optic cable.

Similar to DTS, DAS/DVS offers several advantages over traditional point-based vibration sensors: High spatial resolution: It can measure vibrations with high granularity, pinpointing the exact location of the source along the cable; Long distances: It can monitor vibrations over large areas, covering several kilometers with a single fiber optic sensor cable; Continuous monitoring: It provides a continuous picture of vibration activity, allowing for better detection of anomalies and trends; Immune to electromagnetic interference (EMI): Fiber optic cables are not affected by electrical noise, making them suitable for use in environments with strong electromagnetic fields.

DAS/DVS technology has a wide range of applications, including: Structural health monitoring: Monitoring bridges, buildings, and other structures for damage or safety concerns; Pipeline monitoring: Detecting leaks, blockages, and other anomalies in pipelines for oil, gas, and other fluids; Perimeter security: Detecting intrusions and other activities along fences, pipelines, or other borders; Geophysics: Studying seismic activity, landslides, and other geological phenomena; and Machine health monitoring: Monitoring the health of machinery by detecting abnormal vibrations indicative of potential problems.

With the above in mind, we note again that disasters and outages can lead to extensive damage to power, communication, and transportation infrastructure. Restoring these critical systems is often a challenging and time-consuming process due to limited resources and the need for coordination among various stakeholders. The systems and methods according to aspects of the present disclosure address several key problems and challenges faced during the restoration of power, communication, and transportation infrastructure following a disaster or outage. These problems include at least the following.

Inefficient resource allocation: Traditional methods for allocating resources, such as repair crews, equipment, and materials, often rely on manual assessment and limited data. This can lead to inefficiencies in resource allocation, causing delays in the restoration process and wasting valuable resources.

Lack of real-time monitoring: Existing systems may not provide real-time monitoring of the infrastructure, which makes it difficult to identify damaged or affected areas quickly. This can hinder the ability to promptly address critical issues and prioritize restoration efforts.

Inadequate prioritization: Without accurate and real-time information, it is challenging to prioritize restoration efforts effectively. This can result in repair crews being dispatched to less critical areas, while more severely affected regions are left unattended, prolonging the overall recovery time.

Poor coordination among infrastructures: Power, communication, and transportation systems often operate independently, with little or no coordination during restoration efforts. This lack of coordination can cause delays, confusion, and inefficiencies, further complicating the restoration process.

Limited resilience and redundancy: Traditional methods may not adequately identify potential vulnerabilities and weaknesses in the infrastructure. This can lead to a lack of redundancy in critical components, making the systems more susceptible to future failures or damage.

Insufficient preventive maintenance: Existing approaches may not effectively identify signs of wear, corrosion, or other potential issues that could lead to future failures or damage. This lack of preventive maintenance can result in a higher likelihood of future outages and increased costs for repairs.

Systems and methods according to aspects of the present disclosure provide resource allocation in the restoration of power, communication, and transportation infrastructure using distributed fiber optic sensing technology. By implementing this novel approach, our inventive systems and methods provide an efficient and effective solution to the challenges faced during the restoration process following a disaster or outage. It advances the state of the art by introducing real-time monitoring, improved prioritization, better coordination among infrastructures, increased resilience and redundancy, and effective preventive maintenance.

Our inventive systems and methods comprise a network of fiber optic sensors installed on power lines, communication networks, and transportation systems, which continuously monitor the infrastructure and provide real-time data. This data is collected, processed, and analyzed by a data processing and analysis system, which identifies the affected areas and assesses the severity of the damage.

The prioritization and resource allocation system uses this analysis to prioritize restoration efforts and allocate resources such as repair crews, equipment, and materials to the areas with the highest priority.

In addition, a coordination and communication system establish a communication link among power, communication, and transportation systems, facilitating better coordination and collaboration during the restoration process. The resilience and redundancy enhancement system uses the data collected from the fiber optic sensors to identify potential vulnerabilities and weaknesses in the infrastructure and assists in creating redundancies to enhance the resilience of the systems. Lastly, the preventive maintenance system leverages the continuous monitoring provided by distributed fiber optic sensing to detect signs of wear, corrosion, or other potential issues and schedules preventive maintenance to minimize the risk of future failures or damage.

We note that the above systems may be separate or individual or a combination of circuitry and software operating on a programmable computer and/or processors. Alternatively, it may comprise a programmable computer or processor including storage including instructions that when executed by the computer and/or processors, perform the functions noted.

The systems and methods according to aspects of the present disclosure significantly advance the state of the art by providing a more efficient and effective solution for infrastructure restoration. By leveraging distributed fiber optic sensing technology, the invention enables real-time monitoring of critical infrastructure, improved prioritization of restoration efforts, more efficient allocation of resources, better coordination among infrastructures, increased resilience and redundancy, and effective preventive maintenance, resulting in reduced downtime and minimized impact on affected communities.

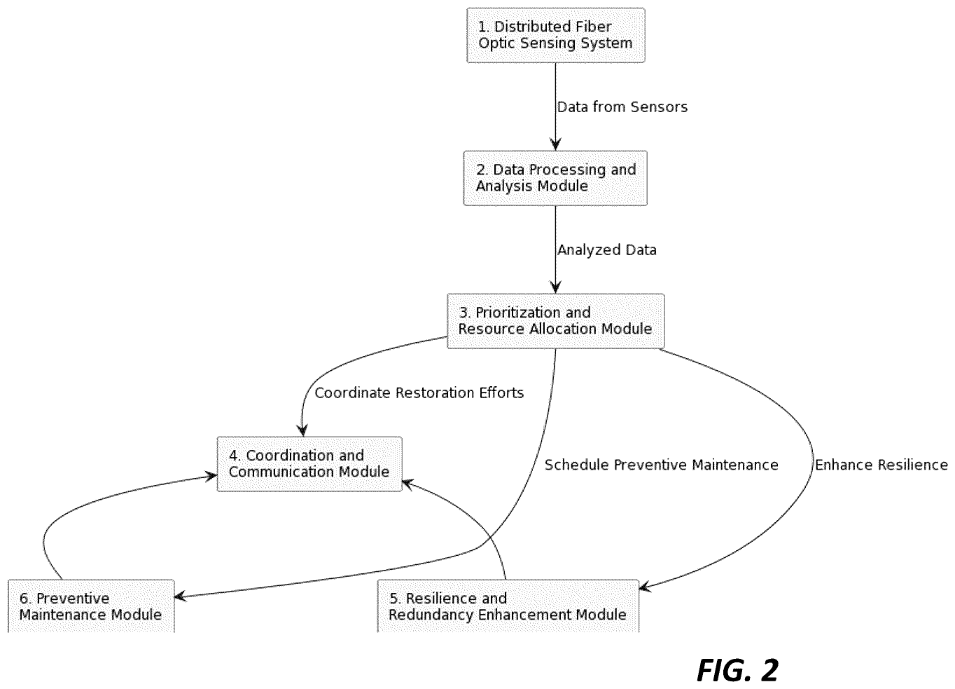

FIG. 2 is a schematic diagrams showing illustrative inter-operation of components of systems and methods according to aspects of the present disclosure.

Distributed Fiber Optic Sensing System: This is the starting point of the process, where fiber optic sensors continuously monitor the power, communication, and transportation infrastructure. The sensors collect real-time data and send it to the next step.

Data Processing and Analysis System: The collected data from the sensors is processed and analyzed by this system. It identifies the affected areas and assesses the severity of the damage. The analyzed data is then sent to the next step.

Prioritization and Resource Allocation System: This system uses the analyzed data to prioritize restoration efforts based on the severity of the damage and the criticality of the affected areas. It also allocates resources, such as repair crews, equipment, and materials, to the areas with the highest priority. This system then sends instructions to the following systems:
Coordination and Communication System
Resilience and Redundancy Enhancement System
Preventive Maintenance System

Coordination and Communication System: This system establishes a communication link among power, communication, and transportation systems, allowing for better coordination and collaboration during the restoration process. It shares coordination data with the Resilience and Redundancy Enhancement System and the Preventive Maintenance System.

Resilience and Redundancy Enhancement System: Using the collected data and coordination information from the Coordination and Communication System, this system identifies potential vulnerabilities and weaknesses in the infrastructure. It assists in creating redundancies to enhance the resilience of the systems.

Preventive Maintenance System: This system leverages the continuous monitoring provided by the distributed fiber optic sensing system and the coordination information from the Coordination and Communication System to detect signs of wear, corrosion, or other potential issues in the infrastructure. It schedules preventive maintenance to minimize the risk of future failures or damage, thereby increasing the overall reliability and resilience of the power, communication, and transportation systems.

As previously noted, the functions/processes performed by the systems/modules/structures/circuitry noted in this disclosure may be performed by specialized circuitry, circuitry within other systems including computers, processors, systems on a chip, etc., including such systems that are programmable and perform the functions/processes as a result of executing stored program instructions provided on non-transitory computer readable medium.

At this point those skilled in the art will recognize particularly distinguishing aspects of the present disclosure that contribute to solving the problem of efficient resource allocation for power, communication, and transportation infrastructure restoration. Such aspects include the following.

Distributed Fiber Optic Sensing: The use of fiber optic sensors to simultaneously monitor power, communication, and transportation infrastructure in real-time, which enables early detection of issues and continuous assessment of the infrastructure's status.

Data Processing and Analysis System: The data processing and analysis system processes and analyzes the data collected by the distributed fiber optic sensing system, identifying affected areas and assessing the severity of the damage. This analysis is crucial for prioritizing restoration efforts and allocating resources effectively. The Data Processing and Analysis System introduces the following novel aspects that advance the state of the art in processing and analyzing data collected by distributed fiber optic sensing systems:

Multi-domain Feature Extraction: While traditional analysis methods typically focus on either the time or frequency domain, the data processing and analysis system employs a multi-domain approach, extracting features from both time and frequency domains. This allows for more comprehensive and accurate identification of affected areas and damage severity.

Hybrid Machine Learning Algorithms: The data processing and analysis system employs a hybrid approach by combining multiple machine learning algorithms, such as supervised and unsupervised learning techniques, to improve the accuracy and reliability of damage identification. This innovative approach leverages the strengths of different algorithms while mitigating their individual weaknesses.

Context-aware Severity Assessment: The data processing and analysis system incorporates contextual information, such as infrastructure type, age, and materials, into the severity assessment process. This context-aware approach enables a more accurate and reliable evaluation of the damage's impact on the infrastructure system's functionality.

Dynamic Thresholding: The data processing and analysis system employs dynamic thresholding techniques that adapt to changing conditions and sensor performance over time. This innovative method helps maintain high sensitivity and specificity in damage detection and severity assessment, even as the monitored infrastructure ages or environmental conditions change.

Real-time Processing and Analysis: The data processing and analysis system is designed to process and analyze data in real-time, enabling rapid identification of affected areas and damage severity. This real-time capability allows stakeholders to initiate restoration efforts and allocate resources more quickly, minimizing the potential impact of the damage.

By incorporating these novel aspects, the Data Processing and Analysis System advances the state of the art in processing and analyzing data collected by distributed fiber optic sensing systems. These innovations enable more accurate and reliable identification of affected areas and assessment of damage severity, which is crucial for prioritizing restoration efforts and allocating resources efficiently.

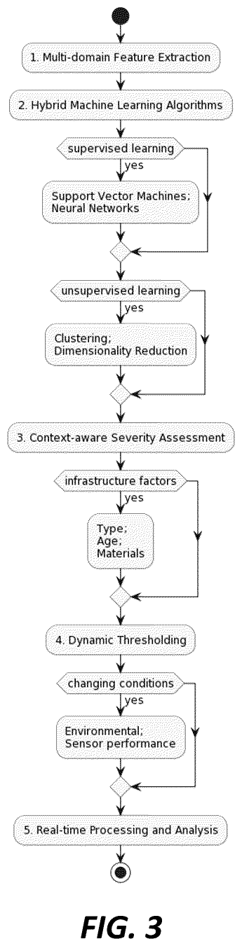

FIG. 3 is a schematic flow diagram showing illustrative operational flow of systems and methods according to aspects of the present disclosure.

Prioritization and Resource Allocation System: This prioritization and resource allocation system uses the analyzed data to prioritize restoration efforts based on the severity of the damage and the criticality of the affected areas, ensuring that the most urgent problems are addressed first. It also allocates resources efficiently, considering the needs of different infrastructure systems and their interdependencies. In this module, we propose the Adaptive Prioritization and Allocation (APA) method.

A dynamic approach that continuously updates the prioritization and resource allocation based on real-time data from the distributed fiber optic sensing system. This adaptive method allows the system to respond to changing conditions and new information, ensuring that the restoration efforts remain focused on the most critical areas.

Update infrastructure damage, functionality loss, and interdependency factors including:
Infrastructure_damage=f1(Infrastructure_damage, Real-time_data);
Functionality_loss=f2(Functionality_loss, Real-time_data); and
Interdependency_factors=f5(Interdependency_factors, Real-time_data) (where f1, f2, and f5 are functions that update the infrastructure damage, functionality loss, and interdependency factors, respectively, based on real-time data).

Recalculate severity using updated information and interdependency factors including:
Severityδ * Infrastructure_damage+ε * Functionality_loss+ζ * Interdependency_factors (where δ and ε are used as the weighting factors for infrastructure damage and functionality loss, respectively, ζ is the weighting factor for interdependency factors).

Update the criticality score, if necessary, using real-time data:
Criticality=f3(Criticality, Real-time_data) (where f3 is a function that updates the criticality based on real-time data).

Recalculate the Criticality-Severity Index (CSI) using updated severity and criticality:
CSI=Criticality_new * Severity_new
Re-prioritize restoration efforts based on updated CSI values.

Re-allocate resources based on the new priorities and any changes in resource availability:
Resource_allocation_new=f4(Resource_allocation, CSI, Resource_availability_changes) (where f4 is a function that updates the resource allocation based on the new CSI values and changes in resource availability).

Coordination and Communication System: This system establishes a communication link among power, communication, and transportation systems, enabling better coordination and collaboration during the restoration process. Improved coordination ensures that resources are utilized effectively and that restoration efforts are streamlined.

The Coordination and Communication System is a part of the overall system that aims to improve the restoration process of power, communication, and transportation infrastructures. This module is responsible for facilitating communication and coordination between the different infrastructure systems, enabling them to work together more effectively during the restoration process.

Here's a clearer explanation of the Coordination and Communication System:

Communication link: The coordination and communication system establishes a communication link or network that connects the power, communication, and transportation systems. This communication link can be built using existing communication channels, such as wireless networks or dedicated data lines, or by distributed fiber optic sensing systems as mentioned earlier. The communication link allows for the exchange of information, such as the status of each infrastructure, the progress of restoration efforts, and the availability of resources, among the different systems.

Coordination: With the communication link established, the Coordination and Communication System enables better coordination among the power, communication, and transportation systems. This coordination can involve sharing information about the restoration progress, aligning restoration efforts and priorities, and coordinating the allocation of resources to address interdependencies between the systems. Improved coordination ensures that resources are utilized effectively and that restoration efforts are streamlined.

Collaboration: The coordination and communication system also facilitates collaboration between the different infrastructure systems, which can lead to more efficient restoration efforts. For example, power and communication systems can work together to identify and address overlapping issues or areas where their restoration efforts can be combined. This collaboration can reduce duplication of efforts, increase the overall efficiency of the restoration process, and minimize the time required to restore the systems to full functionality.

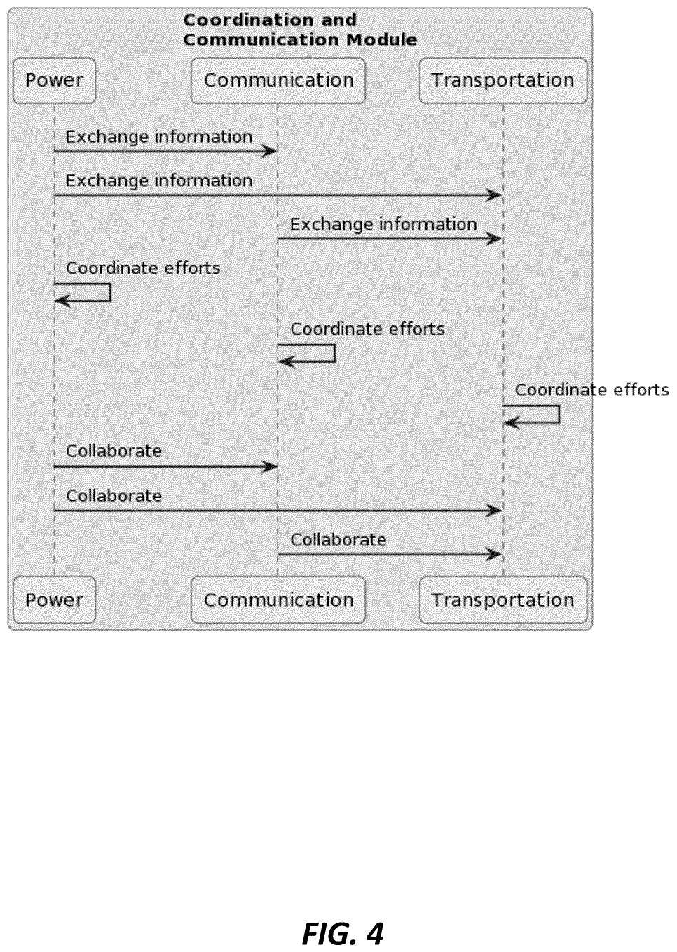

FIG. 4 is a schematic flow diagram showing illustrative coordination and communication of systems and methods according to aspects of the present disclosure.

Resilience and Redundancy Enhancement System: By identifying potential vulnerabilities and weaknesses in the infrastructure, this module assists in creating redundancies and enhancing the resilience of the systems. This feature helps minimize the impact of future disasters or outages on the infrastructure. The Resilience and Redundancy Enhancement System focuses on improving the infrastructure's robustness and ability to withstand future disasters or outages. The module introduces several novel aspects to enhance resilience and redundancy in power, communication, and transportation infrastructure systems. These novel aspects include at least the following.

Advanced vulnerability detection: Utilizing machine learning algorithms and data analytics, the module identifies potential vulnerabilities and weaknesses in the infrastructure systems that may not be readily apparent through conventional methods. This advanced detection allows for more accurate identification of areas requiring reinforcement or redundancy.

Adaptive redundancy creation: The resilience and redundancy enhancement system uses real-time data and predictive analytics to create redundancies dynamically, ensuring that backup systems or alternate routes are available when needed. This adaptive approach enables a more efficient allocation of resources and minimizes the impact of future disasters or outages.

Cross-system resilience analysis: The resilience and redundancy enhancement system takes into account the interdependencies between power, communication, and transportation infrastructure systems, analyzing their combined resilience to better understand the overall system's ability to withstand disruptions. This comprehensive analysis allows for more informed decision-making when prioritizing resilience enhancement efforts.

Continuous monitoring and improvement: The resilience and redundancy enhancement system constantly monitor the infrastructure systems, using real-time data and feedback from ongoing resilience and redundancy efforts to adapt and improve the systems further. This continuous improvement ensures that the infrastructure remains resilient in the face of evolving threats and changing conditions.

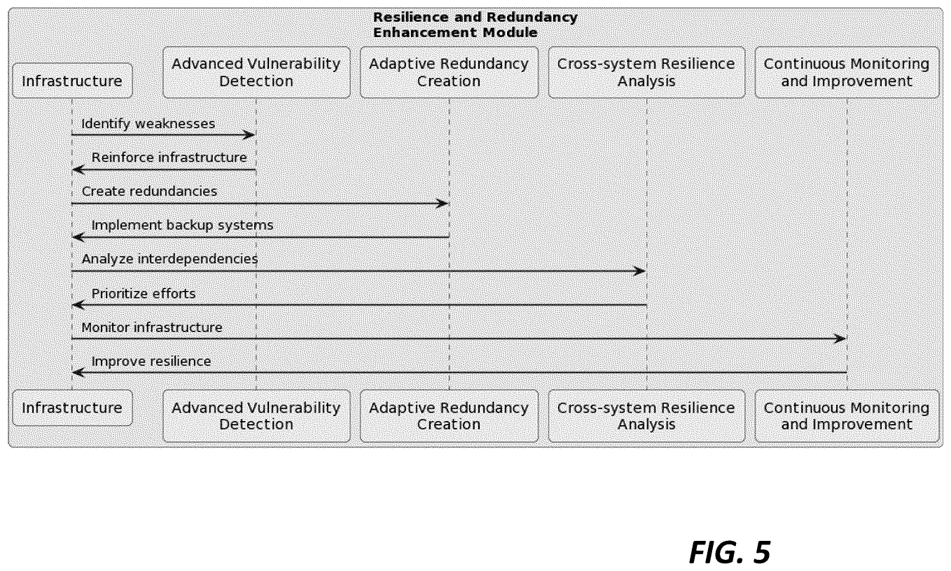

FIG. 5 is a schematic flow diagram showing illustrative resilience and redundancy enhancement operation of systems and methods according to aspects of the present disclosure.

Preventive Maintenance System: This preventive maintenance system leverages continuous monitoring provided by distributed fiber optic sensing and coordination information to detect signs of wear, corrosion, or other potential issues. It schedules preventive maintenance, which reduces the risk of future failures or damage, ultimately improving the overall reliability of the power, communication, and transportation infrastructure. The Preventive Maintenance System aims to enhance the overall reliability of power, communication, and transportation infrastructure by proactively addressing potential issues before they lead to failures or damage. The preventive maintenance system introduces several novel aspects that advance the state of the art in preventive maintenance.

Distributed fiber optic sensing integration: The preventive maintenance system leverages the continuous monitoring provided by distributed fiber optic sensing technology, which allows for real-time, high-resolution detection of signs of wear, corrosion, or other potential issues within the infrastructure systems. This advanced sensing technology enables earlier detection of problems and more accurate identification of maintenance needs.

Coordination information utilization: By incorporating coordination information from the Coordination and Communication System, the Preventive Maintenance System can better understand the interdependencies between power, communication, and transportation infrastructure systems. This knowledge allows the preventive maintenance system to schedule preventive maintenance in a way that minimizes disruption to other systems, ensuring seamless operation during maintenance activities.

Predictive analytics: The preventive maintenance system uses machine learning algorithms and data analytics to predict potential issues based on historical data, real-time monitoring information, and expert knowledge. This predictive capability allows for more informed decision-making regarding preventive maintenance and helps prioritize the most critical maintenance tasks.

Dynamic maintenance scheduling: The preventive maintenance system adapts the preventive maintenance schedule based on real-time information, changes in the situation, and feedback from ongoing maintenance efforts. This dynamic approach ensures that resources are allocated efficiently and that maintenance activities are conducted at the optimal time to minimize the risk of future failures or damage.

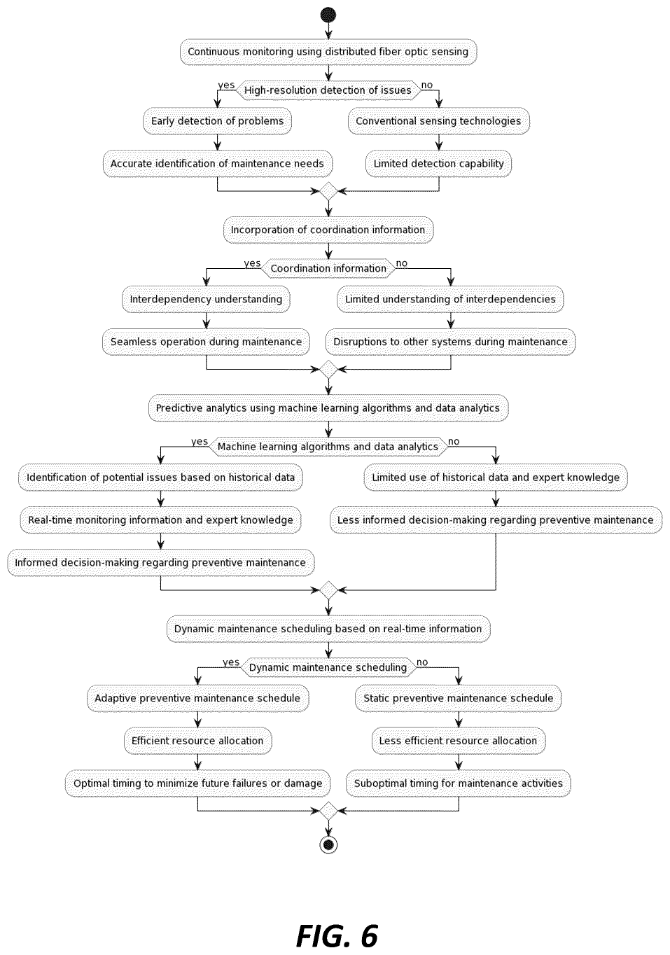

FIG. 6 is a schematic flow diagram showing illustrative preventative maintenance flow of systems and methods according to aspects of the present disclosure.

The flowchart describes the steps involved in the Preventive Maintenance System, which aims to enhance the overall reliability of power, communication, and transportation infrastructure. The module incorporates several novel aspects to advance the state of the art in preventive maintenance.

Starting from the top, the flowchart begins with the input of data from distributed fiber optic sensing technology, which allows for real-time detection of signs of wear, corrosion, or other potential issues within the infrastructure systems. This data is then processed and analyzed using machine learning algorithms and data analytics, which provide predictive capability for potential issues based on historical data and real-time monitoring information.

The preventive maintenance system also leverages coordination information from the Coordination and Communication System to better understand the interdependencies between power, communication, and transportation infrastructure systems. This knowledge allows for dynamic maintenance scheduling that minimizes disruption to other systems, ensuring seamless operation during maintenance activities.

The output of this process is a prioritized list of preventive maintenance tasks, which are then scheduled and conducted using dynamic maintenance scheduling. This adaptive approach ensures that resources are allocated efficiently and that maintenance activities are conducted at the optimal time to minimize the risk of future failures or damage

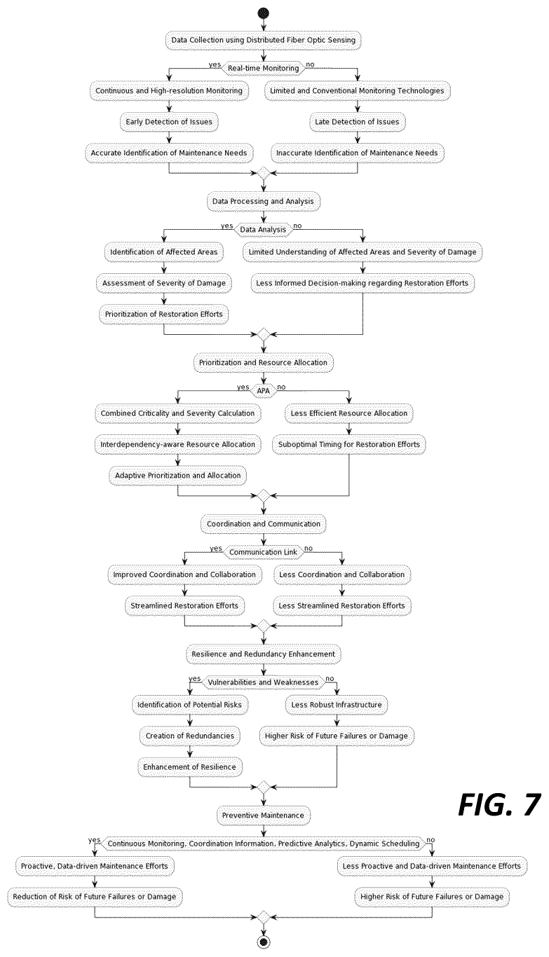

FIG. 7 is a schematic flow diagram showing illustrative overall operational flow of systems and methods according to aspects of the present disclosure.

At this point, an overall operational view of our inventive systems and methods according to aspects of the present disclosure is noted.

### Real-time Data Collection and Analysis Using Distributed Fiber Optic Sensing (DFOS)

The DFOS technology continuously monitors the infrastructure systems, allowing for real-time data collection and analysis.

The DFOS integration involves the installation of fiber optic cables along the infrastructure systems, which act as distributed sensors.

The sensing cables provide high-resolution detection of various physical parameters, such as temperature and strain, which are indicators of potential issues or damage within the infrastructure.

The data collected by DFOS is processed and analyzed by the Data Processing and Analysis System, which identifies affected areas and assesses the severity of damage.

This information is then used by other systems to prioritize restoration efforts and allocate resources effectively.

### Coordination and Communication System for Improved Collaboration and Resource Allocation

The Coordination and Communication System establishes a communication link among power, communication, and transportation systems. This system enables better coordination and collaboration during the restoration process, ensuring that resources are utilized effectively and that restoration efforts are streamlined. The Coordination and Communication System allows the other systems to understand the interdependencies between different infrastructure systems and their components. This knowledge is used by the systems to schedule restoration and maintenance activities in a way that minimizes disruption to other systems, ensuring seamless operation during maintenance activities.

Criticality-Severity Index (CSI) for prioritization of restoration efforts based on severity of damage and criticality of affected areas. The CSI is a novel index that combines the criticality of the affected area (e.g., population density, economic impact, social importance) and the severity of the damage to produce a single prioritization score. The CSI enables more accurate and efficient prioritization of restoration efforts, ensuring that the most urgent problems are addressed first. The CSI equations are used by the Prioritization and Resource Allocation System to assign a prioritization score to each affected area based on the severity of the damage and the criticality of the affected area. The prioritization scores are then used to prioritize restoration efforts, ensuring that the most critical areas are addressed first.

### Implement Adaptive Prioritization and Allocation (APA) for Dynamic Adaptation of Restoration Efforts Based on Real-Time Information and Feedback

The APA is a method that adapts the prioritization and resource allocation process based on real-time information, changes in the situation, and feedback from ongoing restoration efforts.

The APA enables more responsive and efficient resource allocation as new information becomes available and priorities change. The APA equations are used by the Prioritization and Resource Allocation Module to dynamically adapt the prioritization and allocation of resources based on real-time information, ensuring efficient use of resources and prioritization of critical areas.

### Resilience and Redundancy Enhancement System for Identification of Potential Vulnerabilities and Weaknesses in Infrastructure Systems and Creation of Redundancies to Enhance Resilience

This system assists in creating redundancies and enhancing the resilience of the systems, minimizing the impact of future disasters or outages on the infrastructure.

The Resilience and Redundancy Enhancement System uses novel features such as multi-domain feature extraction, hybrid machine learning algorithms, and context-aware severity assessment to identify potential issues and enhance the resilience of the infrastructure systems.

Preventive Maintenance System: The Preventive Maintenance System leverages continuous monitoring provided by DFOS and coordination information to detect signs of wear, corrosion, or other potential issues. It schedules preventive maintenance, which reduces the risk of future failures or damage, ultimately improving the overall reliability of the power, communication, and transportation infrastructure. The module introduces several novel aspects that advance the state of the art in preventive maintenance, such as distributed fiber optic sensing integration, coordination information utilization, predictive analytics, and dynamic maintenance scheduling

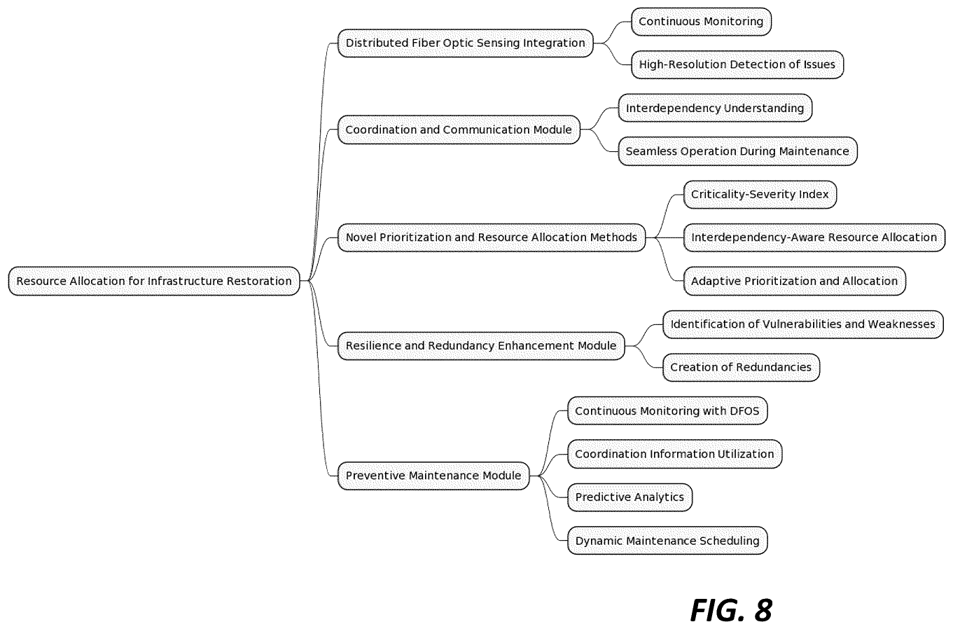

FIG. 8 is a schematic diagram showing illustrative feature hierarchy systems and methods according to aspects of the present disclosure.

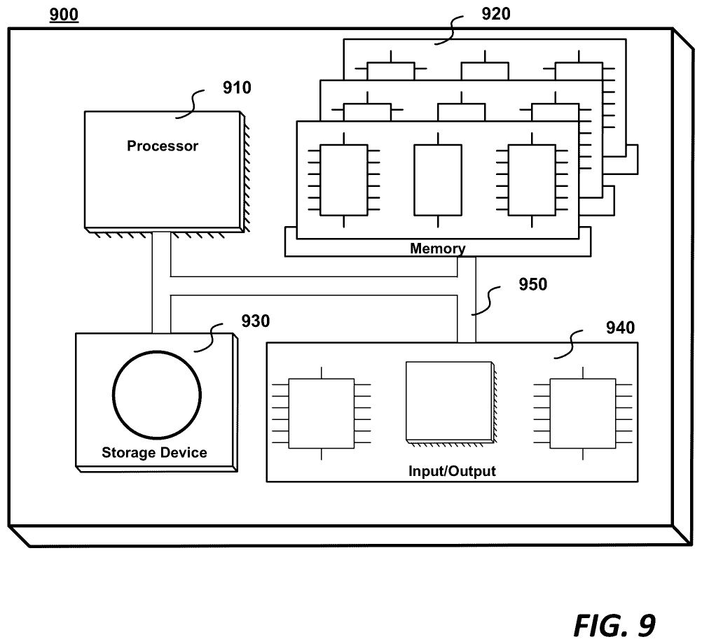

FIG. 9 is a schematic block diagram of an illustrative computing system that may be programmed with instructions that when executed produce the methods/algorithms according to aspects of the present invention.

As may be immediately appreciated, such a computer system may be integrated into another system such as a router and may be implemented via discrete elements or one or more integrated components. The computer system may comprise, for example, a computer running any of a number of operating systems. The above-described methods of the present disclosure may be implemented on the computer system 900 as stored program control instructions.

Computer system 900 includes processor 910, memory 920, storage device 930, and input/output structure 940. One or more input/output devices may include a display 945. One or more busses 950 typically interconnect the components, 910, 920, 930, and 940. Processor 910 may be a single or multi core. Additionally, the system may include accelerators etc., further comprising the system on a chip.

Processor 910 executes instructions in which embodiments of the present disclosure may comprise steps described in one or more of the Drawing figures. Such instructions may be stored in memory 920 or storage device 930. Data and/or information may be received and output using one or more input/output devices.

Memory 920 may store data and may be a computer-readable medium, such as volatile or non-volatile memory. Storage device 930 may provide storage for system 900 including for example, the previously described methods. In various aspects, storage device 930 may be a flash memory device, a disk drive, an optical disk device, or a tape device employing magnetic, optical, or other recording technologies.

Input/output structures 940 may provide input/output operations for system 900.

While we have presented our inventive concepts and description using specific examples, our invention is not so limited. Accordingly, the scope of our invention should be considered in view of the following claims.

1. A computer implemented method for resource allocation in response to infrastructure damage, the computer including a processor and a memory containing instructions that when executed by the processor cause the computer to:
receive distributed fiber optic sensing (DFOS) data;
analyze the received DFOS data and from the analyzed data, identifying areas in which infrastructure damage has occurred; and
prioritizing restoration efforts and allocating resources to the identified areas in which the infrastructure damage has occurred.

2. The method of claim 1 further comprising establishing communications among power, communication, and transportation systems.

3. The method of claim 2 further comprising scheduling preventative maintenance of the infrastructure.

4. The method of claim 1 in which the resources allocated are selected from the group consisting of repair crews, equipment, and material.

5. The method of claim 4 in which the resources are allocated to identified areas having priority over other areas.

6. The method of claim 5 wherein the DFOS data is analyzed in both time and frequency domains such that the method provides a multi-domain feature extraction.

7. The method of claim 6 wherein the infrastructure damage is identified by multiple machine learning algorithms including supervised and unsupervised learning models.

8. The method of claim 7 wherein the infrastructure damage is identified contextually, by infrastructure type, age, and material.

9. The method of claim 8 wherein the infrastructure damage identification is performed according to a dynamic thresholding that adapts to changing conditions and DFOS sensor performance over time.

10. The method of claim 9 wherein the infrastructure damage identification is performed in real-time such that restoration efforts and resource allocation are performed timely.
